(19) United States
(12) Patent Application Publication
(10) Pub. No.: US 2021/0310353 A1
(43) Pub. Date: Oct. 7, 2021

(54) Nuclear power heavy construction, mining and processing apparatus to make Exo-planetary infrastructures operational for enmasse strategic minerals and water mining production

(71) Applicant: John Aylmer, Winter Park, FL (US)

(72) Inventor: John Aylmer, Winter Park, FL (US)

(21) Appl. No.: 15/267,421

(22) Filed: Sep. 16, 2016

(51) Int. Cl. E21C 51/00; E21C 33/00; E21C 41/00; E21F 17/00; E04H 14/00; E04H 9/16; E21B 7/00; E21B 7/14; E21B 41/00; E02F 9/20; G05D 1/02; C02F 1/44

(52) U.S. Cl. CPC E21C 51/00; C02F 2103/10; E21C 41/00; E21F 17/00; E04H 14/00; E04H 9/16; E21B 7/008; E21B 7/14; E21B 41/00; E02F 9/20; G05D 1/0297; C02F 1/441; C02F 1/444; C02F 2303/04; E21C 33/00

(57) ABSTRACT

This invention is a continuum of enabling technology applying prior patent applications to create and then sustain a planetary heavy construction, soil and water mining and refining using a nuclear power appliances infrastructure. The methods used within this invention provide capabilities to build a sustainable support environment for earth-like habitable complexes that will include buildings and maintenance facilities, living spaces, and office spaces focused on full scale commercial mining operations for He3, H₂O and other strategic minerals and raw building materials.

### CROSS REFERENCE TO RELATED APPLICATIONS

This application claims are divisional and benefits of:
U.S. Non-Provisional application Ser. No. 15/055,606 filed on 28 Feb. 2016 which is hereby incorporated by reference in its entirety [P0201];
U.S. Non-Provisional application Ser. No. 15/047,316 filed on 18 Feb. 2016 which is hereby incorporated by reference in its entirety [P03];

U.S. Non-Provisional application Ser. No. 15/048,670 on 19 Feb. 2016, which is hereby incorporated by reference in its entirety [P0301];
U.S. Non-Provisional application Ser. No. 14/998,744 filed on 9 Feb. 2016 which is hereby incorporated by reference in its entirety [P04]; and
U.S. Non-provisional application Ser. No. 15/202,633 filed on 6 Jul. 2016 which is hereby incorporated by reference in its entirety [P09].

### JOINT RESEARCH AGREEMENTS

Does not apply.

### SEQUENCE LISTING

Does not apply.

### STATEMENT REGARDING PRIOR DISCLOSURES

Does not apply.

### BACKGROUND

The history of designing building structures, bases, and mining on the moon and other planets is not new with many rhetorical concepts on how to achieve this goal. Every concept herein has a common linkage to a formidable plurality of materiel solution gaps lacking heavy construction equipment with a sustainment infrastructure.

On Jun. 9, 1959, the United States Army decided that the construction of a lunar outpost was of great importance to the country. Project Horizon was the idea of—establishing a Lunar Outpost in response to growing interest of other nations like the Soviet Union, which were intent on the militarization and exploration of the moon. Their outpost's primary goal was to protect potential United States interests on the lunar surface. However, not only was Project Horizon the first step of lunar militarization, but also was designed so it could serve as a permanent manned installation on the moon; which eventually would allow the investigation of scientific, commercial, as well as military potential on the lunar surface. The lunar outpost was intended to serve as an observation post, which would facilitate—in the near future—travel between Earth, the moon and eventual exploration of our solar system and beyond.

The Army's Project Horizon concept, planning, and requirements were sound.

Nevertheless, implementation of the Army plans necessitated the use of the state of the art Saturn V—a three-stage rocket. The cost per launch and small weight carried aloft would be prohibitive to a successful completion. Carrying and landing heavy construction equipment and related construction materials would be unachievable. Other major gaps were no return flights and no capability of self-sustainment. This historical case mirrors the present planned Mars landing and habitat.

During 1967, the US Air Force Lunex Project planned to make its first lunar landing and return in order to beat the Soviets and demonstrate conclusively that America could win future international competition in technology with the USSR. Being conceived in 1961, the Project requirements were for establishment of a 21 airman underground Air Force base on the Moon by 1968 at a total cost of $7.5 billion. Many technical issues and unachievable materiel gaps arose, such as:
Re-entry at 37,000 feet per second with a flight path within a very small two-degree angle to avoid overheating or skipping out of the Earth's atmosphere. The latter wouldn't kill the crew directly but would leave the Earth-return spacecraft in an elliptical orbit where they might be exposed to excessive radiation in the Van Allen belts as well as other radiation sources before the next re-entry opportunity;
Development of the lunar landing stage, which would have to make a precision landing tail-first on rocket thrust had never been previously tested; and
Development of the lunar launching stage, which had no backup capability requiring it be extremely reliable and capable of automated checkout on the lunar surface while being capable of putting the crew into a precise orbit to return to Earth. It remains untested.

Moving on to Dec. 4, 2006, NASA announced the conclusion of its Global Exploration Strategy and Lunar Architecture Study. The Lunar Architecture Study's purpose was to “define a series of lunar missions constituting NASA's Lunar campaign to fulfill the Lunar Exploration elements” of the Vision for Space Exploration. What resulted was a basic plan for a lunar outpost near one of the poles of the Moon, which would permanently house astronauts in six-month shifts. This lunar outpost was an element of the George W. Bush era Vision for Space Exploration, which has been replaced with President Barack Obama's space policy. The outpost would have been an inhabited facility on the surface of the Moon. At the time it was proposed, NASA was to construct the outpost over the five years between 2019 and 2025. The NASA Implementing Vision 2^{nd} Space Exploration Conference Brief provides Slides 15 and 16 that show the US build of the transportation infrastructure and capabilities by 2025 that would provide for an:
Open Architecture wherein NASA will welcome external development of lunar surface infrastructure;
Perform early demonstrations to encourage subsequent development;
External parallel development of NASA's capabilities will be welcomed;
Mature transportation systems;
Closed loop habitation;
Long duration human missions beyond LEO;
Surface EVA and mobility;
Autonomous operations;
Advanced robotic missions;
Minimize reliance on Earth via In-Situ fabrication and resource utilization;
Enhanced by Commercial and International Partners;
Continue to engage academia, the private sector, and other stakeholders in defining a sustainable program of exploration.

In a close examination of the devices and structures in this 2006 brief, no significant changes had been made from the 1959 approach. In 1959, everything had been buried underground; but now the structures appear to be inflatable structures above ground.

In a materiel solution gap analysis of this 2006 approach, the following issues are:
transorbital and trans-planetary transportation infrastructures were not established or commercially viable;
lack of capability and sustainment of heavy construction and mining equipment with planetary materials processing infrastructures; and
Human safety provided by these structures on the surface of the Moon is significantly lacking due to the exposure to cosmic rays, neutrons, solar flares, breathtaking vacuum, extreme temperatures and space radiation which top the list. In addition, as cosmic rays hit the ground, they produce a dangerous spray of secondary particles right at their feet. This radiation penetrating human flesh can damage DNA, boosting the risk of cancer and other maladies. (Re: NASA Report Sep. 8, 2005)

Advancing to 2013, Christopher McKay, a planetary scientist with NASA stated, “Things are starting to really heat up in terms of exploration of the moon.” Whereas, Henry Herzfeld, who teaches space law at George Washington University in Washington, D.C., expressed some concern about NASA's role in future missions to the moon. “We're seeing a lot of partnerships forming without the United States. It may be that we're being left out of something we started because we've pulled back and focused on other things.” What has been depicted in graphics of these McKay concepts has not significantly changed from the 1959 or 2006 approaches. These 2013 materiel solution gaps mirror the 2006 with just an upgrade in technology, which does not address the root cause of these gaps.

Progressing to 2016 and beyond, Alliant Techsystems (ATK) division Orbital ATK's Space Systems Group unveiled their preliminary plans to place a four-person habitat in cislunar space by 2020 using 1962-style equipment. This announcement came during testimony to the U.S. House of Representatives Subcommittee on Space would provide the creation of a permanent human presence in lunar orbit by the start of the next decade. The same vast materiel/process gaps apply to this effort also.

Looking forward, NASA's agency-wide goal is to send astronauts on a ‘Journey to Mars’ by 2030s. However, before this journey begins, expeditions to cislunar space in the 2020s will serve as the vital ‘proving ground’ to fully develop, test out and validate the robustness of crucial technologies upon which the astronauts' lives will depend on later during each

Red Planet mission, which should last some 2 to 3 years. What NASA has planned for lunar/Mars habitation will be above ground inflatable structures. These structures would make use of the agency's new Space Launch System (SLS) and Orion deep-space transportation system. Manned missions of SLS and Orion to moon orbit and possibly an asteroid flyby are known as Exploration Mission-2 (EM-2).

By the planned 2020 mission, all the brilliant engineering, technical advances and superior research efforts will support furthering the goal of conquering outer space but will still be using 1962-style capsules on stick rockets. Yet, all the materiel solution gaps remain unchanged from the 2006 conference with the said description above. The planned inflatable surface structures have been cited to be hazardous and even lethal for habitation, unsustainable and, most importantly, unaffordable using the SLS expendable rocket. Future commercial profits for return on investments (ROI) for space mining, tourism, and other heavy industries certainly would be investments at high risk using fragile and small underpowered solar-powered equipment.

In every timeline of this invention background, each goal has a common linkage to a formidable plurality of materiel solution gaps lacking heavy construction equipment and a sustainment infrastructure for commercial profit. This invention and its embodiments intend to close those materiel solution gaps with a paradigm shift when applied to all the related applications referenced above.

Going forward, this invention fosters methods for high yield commercial profit utilizing nuclear powered construction, mining and processing equipment in order to provide en masse building of various infrastructures for mining, processing facilities, personnel habitats, and sustaining complexes. A robust trans-planetary and planetary transportation pipelines supports these infrastructures.

### DESCRIPTION OF THE INVENTION

In this present invention, a paradigm shift in methods and apparatus compared to the current NASA and commercial approaches in development of their unsustainable planetary habitation as presented in the above background of this present invention is obtainable. The methods and apparatus cited used within this present invention are instrumental in making achievable the commercial ‘end state’ attained by applying the mission-enabling activities in NASA's Science Mission Directorate (SMD). The SMD embraces support for scientific research and research infrastructure, advanced technology development, as well as scientific and technical workforce development that are “fundamentally important to NASA and to the nation” (ref. NAP.EDU Chapter 10, pg. 283). All of these fields of research are important to NASA's long-term planetary science goals, and all require funding. This NASA funding not only leads to the gathering and dissemination of new scientific knowledge but also lays the groundwork for the future of the field of commercial return on investments in space.

This brilliant NASA research and dissemination of new emerging scientific knowledge must be continued. NASA research would be exponentially increased following the embodiments of the present invention. Nevertheless, the natural “end state” of all this research must be the emergence of profitable commercial and heavy industrial enterprises at a scale equal or greater than to those on earth. These future enterprises in order to produce a sustainable return on investment are challenged by NASA's small solar powered equipment approach. In addition, these enterprises must be designed to operate in remote and harsh environments and must provide for continuous sustainable planetary habitation at an unprecedented scale beyond the presently planned small huts. This scale of construction can only be achieved by using a plurality of new Planetary Major Equipment (PME) apparatuses comprised of heavy construction, mining and processing equipment FIG. 4 on planets and moons. The first generation PME designs would modify existing bulldozers FIG. 3, 12 and all other equipment to become nuclear powered and enhanced for environmental and gamma radiation protection. Bringing heavy equipment to a distant planet and sustaining operations requires the development of several substantial infrastructures working together in a well orchestrated family of events depicted at FIG. 1. These events and future accomplishments of this invention are predicated upon a fully operational trans-orbital freight carrier at FIG. 5, 17 (U.S. Non-Provisional application Ser. No. 15/047,316 dated 18 Feb. 2016, [P03]).

In the first embodiment, a beginning any New Planetary Construction Project (NPCP) for heavy industrial or mining purposes must employ uniform methods to streamline a rapid acquisition, engineering and deployment processes exhibited by the three swim lanes depicted in FIG. 1. This present invention emphasizes the use of open systems, which mandates standard software interfaces, interchangeable components, and training that will greatly facilitate a more rapid updates to cost-effectively incorporate anticipated future technological advances. Further, these methods must provide for an adaptable overview of all exoplanet environmental considerations in the development, testing, and operational phases of all devices to be deployed.

At FIG. 1, a typical NPCP acquisition/fielding strategy is to have a uniform, repeatable task flow methods of mission planning, preparation, and deployment, as defined by the three swim lanes. By adopting a uniform-acquisition/fielding process, the tasks and events depicted in FIG. 1 has a similar execution of tasks as the U.S. Non-Provisional application Ser. No. 15/202,633 dated 6 Jul. 2016 [P09]. Each task box identifies the New Document Procedures (NPD) used in a specific project. On the top right side, P0* numbers relate to the previously cited respective patent applications and the figure numbers showing its application.
In the first swim lane, a new planetary construction project (NPCP) begins with approval of industrial investors or academia requesting and securing funding for container space on a Delivery System. In following the swim lane, six major process elements cover all required contracting and engineering methods to be scheduled and completed, as described in U.S. Non-Provisional application Ser. No. 15/055,606 dated 28 Feb. 2016 [P0201]. The ‘end state’ of this lane is delivery of equipment, kits, and devices and delivered to a specified spaceport for a transport on a Trans-Orbital Freight Carrier as specified in U.S. Non-Provisional application Ser. No. 15/047,316 dated 18 Feb. 2016 [P03] and transported to the space dock at FIG. 6 in geosynchronous orbit as described in U.S. Non-Provisional application Ser. No. 15/048,670 dated 19 Feb. 2016 [P0301]. The final tasks performed is by a program manager is to sends notification to the Pu-238 Nuclear Complex at 20 requesting to build and deliver a miniature nuclear powered reactor module FIG. 2, 2 or 2A. An optional standard battery module may requested to the Space Dock Complex FIG. 6 awaiting incoming kits to be built.
Within the second swim lane, NPCP mission preparation tasks are accomplished at a geosynchronous space dock FIG. 6. It is here that all construction and mining equipment kits, exhibited at FIG. 4, are assembled, built, inspected, tested, and crated FIG. 6, 20 at this space dock. FIG. 3 depicts the installation of a nuclear power pack 1 into any construction and mining equipment kit being further assembled on a planet. The ‘end state’ of all processes for this swim lane is a fully loaded trans-planetary delivery system (TPDS) at FIG. 7, 22A readied for departure.
In the last swim lane, the NPCP mission begins with the departure of a fully loaded TPDS at FIG. 7, 22A from the space dock in FIG. 6. A TPDS mission is pre-programmed with navigational charts to the appropriate destination like the moon or mars at FIG. 11 or water planet at FIG. 12. Along the journey to a planetary destination, Laser Communication & Navigation Modules are deployed, aligned and tested. Arriving at a destination, the construction assets are deployed on the planet surface in FIG. 12. The ‘end state’ of this lane and mission completion is departure of the TPDS to the space dock allowing construction or mining operations to begin.

In the second embodiment, as depicted by FIG. 2, the principal device that supports all methods within this invention is the Pu-238 nuclear-powered containment module 2, 2A or the optional and interchangeable rechargeable battery power pack module 3. A Pu-238 nuclear powered container module 2, 2A coupled to an up-scaled Advanced Sterling Radioisotope Generator (ASRG) or equivalent module 4 engineered to meet the specific planetary application and environment requirements. The ASRG module is a Sterling Converter technology or equivalent that is a highly efficient device that converts heat into electricity without moving parts. This new advanced process is more efficient than the thermoelectric and solar powered systems provides a more efficient means of in producing power.

For any type of construction equipment whether tracked or wheeled, the electric drive system 7 will draw its AC power from the ASRG module 2. The ARSG will provide current that flows through specially armored cables and military grade connectors to a solid-state power inverter 6. Advanced electronics 6 send AC current to the propulsion module 7 to control the motors and provides DC current for the accessory systems. The propulsion module with state-of-the-art AC electric motors, delivers well-modulated torque via axles to the final drives 7.

The combined Pu-238 nuclear power containment module 2, electric drive system 7, solid-state power inverter 6, and the ASRG module 2 are mounted to the universal chassis frame 7, which becomes a standard power train 1 for all construction equipment. A typical installation is exhibited at FIG. 3 with some adaptations for the construction and mining devices as depicted at FIG. 4.

The third embodiment, as represented at FIG. 3, shows a sequential method on earth to build a typical bulldozer starting on the standard engine frame 1. At the end of a build, the GPS antenna systems 8, camera imaging systems 11, and the autonomous remotely piloted navigation network systems 9 are installed. What is not installed on earth is a Pu-238 nuclear power containment module FIG. 6, 2 so as not to incur environmental hardship. Rather, this module 2 is installed and tested at the space dock FIG. 6.

The fourth embodiment depicts conceptual artwork at FIG. 4, which shows the anticipated types of building kits needed to develop a full-scale mining and processing operation on an exoplanet. After a completed construction or mining equipment device kit is built, it is delivered to the earth spaceport FIG. 5. Each kit delivered is under a combination of weight constraints of up to approximately 60 tons and cargo area volume constraints of a trans-orbital carrier FIG. 5, 17. These two constraints drive the requirements to design and develop methods of kitting and assembling.

The fifth embodiment is an exit point for the first swim lane at FIG. 1. In this embodiment, the pipeline process steps of transporting all type of materials, systems, kits employing the same uniform methods fully described in U.S. Non-Provisional application Ser. No. 15/048,670 dated 19 Feb. 2016 [P0301] to loading on the transorbital freight carrier (U.S. Non-Provisional application Ser. No. 15/047,316 dated 18 Feb. 2016 [P03]). This pipeline method and supporting apparatus are a universal solution for referenced patent applications cited.

The dynamics of the sixth embodiment is presented at FIG. 6. It is the entrance point, which begins the second swim lane at FIG. 1 for planetary mission preparation. All future planned planetary construction, mining, and processing infrastructure development begins at a Space Dock Complex (SDC). A complex is comprised of four major modules: the Crew Habitat Module FIG. 6, 19, mission preparation module 18, space docking arm 18A, and the Pu-238 Nuclear Power Pack Complex FIG. 7, 19A. Each Module employs different methods in accomplishing a mission. Highlighted features of this space dock infrastructure are
Continuous methods to build, expand, and sustain an operational DS space dock complex FIG. 6, 18, 19 and FIG. 7, 19A. Each Complex would accelerate experimentation for employing a plurality of earth-like gravity methods such as rotation that would determine the appropriate comfort zone parameters for long term habitation and working conditions in this environment. To protect the spacecraft crew compartments and habitation modules FIG. 6, 18, 19 and FIG. 7, 19A for extensively long trips, a complex plurality of methods for radiation protection of all systems are determined at FIGS. 6 and 7 by employing a water barrier for scattering properties in gamma-ray protection and by combining with other polyethylene/Kevlar composites for other radiation and debris collection protection. Employing the methods of artificial gravity and radiation protection for crew safety and comfort would promote acceptance by commercial enterprises to maintain the complex and perform all tasks required.
The Crew Habitation (CH) Module FIG. 6, 19 and FIG. 7, 19, 19A is a heavily radiation shielded multi-floored complex with unlimited types of modular expansion and further described within U.S. non-provisional application Ser. No. 15/202,633 dated 6 Jul. 2016 [P09]. Being a standalone self-sustaining environment, a CH module FIG. 6 and FIG. 7, 19 is capable of being disconnected from the main space dock complex either for repositioning or as a life boat should the main docking complex incur critical events. A CH Module 19 embraces all the engineering and safety methods and devices needed to provide a comfortable crew living space in an earth-like gravity environment. It is connected to the Space Dock Production Complex FIG. 6, 18.
A Space Dock Production Complex 18 and the associated Space Dock Arm 18A is the main production area for the mission preparation and loading of a Trans-Planetary Delivery System (DS) 22. At this complex 18, inbound crated building kits 12, 13, 14 and other related crated materials 12 are removed from the trans-orbital freight carrier 17 and floated by material handling drones 23 into the cargo bay 18. When inbound crated kits 12, 13, 14 arrive at the Space Dock Complex, the production crew will work to the specific processes needed to assemble construction equipment components and to install the nuclear power containment module 2 or 2A. During the kit assembling, the Nuclear Power Pack Complex 18B will be floated from nuclear power container module 2 or a large module 2A to be mounted in the specific kit being assembled. After a construction equipment kit is finished and tested, the completed equipment and related systems are placed into a Planetary Landing Module 20. It is then removed from the hanger bay 18 and floated with material handling drones 23 for mounting on the awaiting trans-planetary delivery system (DS) 22.
A major and a very critical apparatus to be built, tested, and accepted at this complex 18 is the Dust-off Landing (DoL) Device 19. When a DoL Device 19 is completed, it is grabbed by material handling drones 23 and floated to DS 22 for mounting. The various activities shown in FIG. 6 around the space dock complex FIG. 6, 18, 19 and FIG. 7, 19A depicts methods of moving offloaded cargos FIGS. 6, 12, 13, and 14 and moving nuclear power container modules 2 to the space dock and DS 22 for the propulsion systems. The preparation and loading of the Trans-Planetary Delivery System (DS) 22 becomes the ‘end state’ of the sixth embodiment and the second swim lane tasks of FIG. 1.

The seventh embodiment, as illustrated at FIG. 7 presents the primary apparatus to establish, expand, and sustain the trans-planetary transportation pipeline. This pipeline requires an apparatus, which is a multi-purpose and reconfigurable “Trans-Planetary Delivery System (DS)” FIG. 7, 22, 22A where all methods are fully described within U.S. non-provisional application Ser. No. 15/202,633 dated 6 Jul. 2016 [P09]. ADS 22 is the workhorse for all trans-planetary transportation pipeline deliveries and planetary landings as well as making fully operational all exoplanet construction and mining infrastructure. FIG. 7 exhibits a typical unloaded configuration DS 22 FIG. 7, 22 which shows the DS Payload Mounting Frame sections which provide capabilities to mount the payloads resulting in a loaded configuration 22A FIG. 7, 22A for delivery of construction equipment to requested destinations as seen in FIG. 8. The payload framing sections are designed to permit additional frames to be added as required for a specific mission requirements defined by FIG. 1.

Some additional highlights of a DS are that:
A requirement for an enormous payload mass of a fully loaded configuration DS 22A FIG. 7, 22A to expeditiously deliver construction, mining, and infrastructures for planetary development. Due to extreme mass, a DS requires four to six larger Variable Specific Impulse Magnetoplasma Rocket (VASIMR®) engines with the aid of a set of helper Xenon-ION engines for continuous acceleration to the outer solar system FIG. 8 and return. Propulsion systems are fueled by several Power Package Containers FIG. 6, 2A and autonomously replaced enroute. When exhausted, the containers are internally stored 12 then returned for overhaul and recharging at Nuclear Power Pack Complex 18B for reuse or disposal.
Another unloaded DS 22 FIG. 7, 22 configuration provides methods, procedures, and mounting devices for advanced propulsion systems including possible Alcubierre Warp Drive Mechanics as conceptualized by Dr. Harold White, NASA Johnson Space Center.
An unloaded DS 22 has multiple operational modes such as being remote controlled and/or crewed by astronauts and scientists.
All DS 22 spacecraft are to remain in space where they are maintained in an ‘operational state’ and upgraded as new technology and systems are available.
All DS 22 spacecraft are designed for limited tonnage of processed materials and transport large mass of materials or millions of gallons of gasses or water utilizing specialized space barges displayed at FIG. 12, 85.

Embodiment 8 is the application of the methods and processes of embodiment 7 in the placement and continuous alignment of laser & near-infrared communications relay modules. Although space laser communications systems 27 at FIGS. 7 and 8, are an ever-emerging crosscutting technology, this invention and its related non-provisional application [P09] previously cited provides the capabilities to rapidly build in orbit a new robust, highly advanced relay communications and navigational tracking beam infrastructure required by industrial and mining commercial space enterprises and NASA researchers. The communications methods of this infrastructure would initially provide for an ever expanding thru-put transferring rate at 622+ megabits per second, which is about five times the current state-of-the-art from lunar distances. A laser communication module 27 will have an optical beam of approximately 12 inches and a conceptual green laser beam spiral wrapped in a blue laser to prevent distortion and requiring a clear line of sight between all relay modules and with earth and the planetary deployed systems. Because the relay modules are permanently positioned in hostile deep space, a planetary orbit environment, continuous maintenance and alignment is required. FIG. 6 displays the same radiation protective shell 19A as on all other devices within this present invention and is capable of supporting long-term human habitation. The Space Dock at FIG. 6, 18, 18A is responsible to assemble and make operational an Unmanned Maintenance Space Barge with materiel handling drones 2 at FIG. 6 to remove, replace, align, and repair any degraded performance relay module.

An essential functional element of embodiment 8 is directly drawn from methods of embodiment 7 as depicted at FIG. 7. FIG. 7 depicts placement of communication satellite modules 27 and placement of instrumented satellites and equipment landing modules 19 at FIGS. 6, 7, and 9 on a watery moon or planet. Later, a plurality of electric drive and nuclear powered heavy construction equipment (I.e. Caterpillar D7E) will be landed to aggressively research and to begin for-profit commercial mining of a planets resources.

Embodiment 8 as depicted by FIG. 8 is a panoramic view of a theoretical orbital approach prior to landing to set up a conceptual construction and/or mining infrastructure mission specified under embodiment 1. During the execution of this mission, the DS FIG. 7, 22A payload will begin at earth station and travel to the water world moons around Jupiter or our Moon or Mars mining infrastructures. A mission specialist or planetary scientist will release the landing Equipment Maintenance Facility Module(s) FIG. 10, 40 along with optical/radio communications relay modules FIG. 8, 27.

Ongoing NASA instrumentation research projects will provide initial data collected from other NASA research protocols and capable of being expandable under U.S. non-provisional application Ser. No. 15/202,633 dated 6 Jul. 2016 [P09]. Under the direction of mining scientists, engineering and construction engineering will provide the appropriate new methods for these future construction and mining infrastructures at FIG. 11 and FIG. 12. During the building of these infrastructures, scientists will have new methods to close all information and science gaps by having the capability to sustained long-term corporate planetary assignments. During a NPCP mission, mission specialists or planetary scientists will deploy GPS, imaging satellite instrumentation assets, and heavy equipment packages as well as other NPCP equipment to begin building and make operational a planetary infrastructure. In subsequent NPCP missions, other loaded configurations of DS 22A FIG. 7, 22A will deliver more equipment and planet boring devices, kits like nuclear powered heavy construction, and nuclear powered drilling equipment devices, as adopted from U.S. Pat. No. 3,280,923, dated 25 Oct. 1966.

Embodiment 9, as depicted at FIG. 9, is the landing of the NPCP capital assets and equipment to a specified geo-spatial site using a Dust-off Landing (DoL) Device 19 powered by several VASIMR® propulsion systems 19A. A DoL Device 19 operates under several command modes: (a) mission specialist remotely piloted vehicle by a, (b) artificial intelligence guided landing, (c) autonomous software guided landing, or (d) a combination of all depending on the environmental conditions at the time. FIG. 9 shows the phased methods of departing from an orbiting Delivery System 22 and then making the final approach to the landing zone with an Equipment Maintenance Facility Module FIG. 10, 40. As the DoL Device 19 FIG. 9, 19 starts the landing sequence, procedures control the telescoping landing legs that extend further down and provide for shock absorption and terrain leveling.

When the DoL Device 19 offloads an Equipment Maintenance Facility Module 20 with an exampled front-end Loader 14, the DoL Device 19 would be instructed to return to the DS 22 for use in the next NPCP mission or remain at the site to provide various tasks such as moving facility modules or capital assets to other locations. Planetary mission technicians are responsible for initiating the appropriate methods to make a facility operational to achieve the following embodiment.

Embodiment 10, as illustrated at FIG. 10, illustrates an interior of a typical Equipment Maintenance Facility Module 20 for housing a bulldozer 12. This facility has two levels in two partitioned compartments. In the first partition is the garage and full service bay area 41 where construction equipment is stored between assignments. In the second partitioned compartment, maintenance and repair shop 45 performs sundry methods of electronic, electrical and hardware repairs. Spare parts inventory and cold food storage areas 46 provide support for continued sustainment of this facility. The upper level is the living and entertainment area 44 that provides comfortable accommodation for the crewmembers. On this same level, the operations room 43 permits remote equipment operations performed by the crew. A construction equipment operator will remotely operate the bulldozer 12 to perform assigned work at a specific location. For a typical bulldozer, like all other planetary equipment, work tasks are guided by a combination of methods that involve computer network systems that are performed on and off planet, terrain mapping, image databases, GPS instrumentation, and remote human control. An area of the operations room 43 contains an assortment of simulators and computer network servers and provides mission preparations and after action reviews for the performance of daily tasks. When operational, an Equipment Maintenance Facility Module 20 is one facet of a larger complex where mining and refining for strategic minerals or He3 at FIG. 11 or mining and purification of water on the water planets at FIG. 12 is performed.

The ‘end states’ methods of this invention are visualized at FIG. 4, FIG. 11, and again at FIG. 12, which depicts an environmentally ruggedized, heavy duty, and large size construction and mining enterprise. Methods employed during normal operations are capable of producing continual high return on investments while supporting scientific research methods. These methods of exoplanet mining FIG. 11, 50, and refining 53 and 55 must replicate mining and construction methods here on Earth. Similarly mining, refining and construction methods performed on exoplanets will require the same kind of support infrastructure conceptualized by FIG. 11 and FIG. 12 as used on Earth which provides a self-sustaining and maintenance environment.

Embodiment 11, illustrated at FIG. 11, is a conceptual representation of a Moon or Mars system of systems 50 for strategic materials mining complex connected to a trans-planetary pipeline 59. This complex has a plurality of corporate capital assets needed to support the various typical heavy open pit and tunnel mining methods 51. In many ways, this complex is adopting and adapting mining systems 51, refining methods and heavy equipment, as found in traditional Earth open pit and tunnel mining operations. Within this system of systems 50, the complex has the capability for continual expansion and relocation mobility. After a mining operation completion, the heavy equipment provides for the extra benefits of surface reclaiming and build out of underground complexes if necessary.

Examining FIG. 11, a typical build-out method of a multi-purpose complex starts with the dust-off landings 19 delivering a plurality of Equipment Maintenance Facility Modules 40 represented at FIG. 9 thru FIG. 12. This initial construction equipment is remotely piloted and will initiate the methods for land clearing, soil testing, and smoothing of the surface. Dust-off landings are a continuous succession of deliveries until the mission has been completed and accepted. After clearing, the equipment bays are landed and made operational. Conceptual successions of deliveries permit the initial build out of the modular crew habitat, maintenance, and kit build facilities FIG. 11, 59. At this facility 59, a plurality of methods directs the kit assembling of extremely large equipment for delivery and testing as well as delivery of all heavy construction, drilling and mining equipment 13, 51 and 62 to the site locations.

The nuclear powered boring methods 62, adapted for exoplanetary sites from U.S. Pat. No. 3,280,923 dated 21 Sep. 1962, probe the substrates for strategic metal deposits and suitable materials for use in construction. When relocating is required, boring equipment 61 is disassembled for movement and then reassembled to continue operation.

As a deep open mining operation enlarges, additional requirements for a plurality of mining dump trucks 13 having a range of tonnage from 1 to 352 tons will be required to support the ground pipeline methods transporting materials from open pits to the refineries 53 and 55. Trucks arrive in numerous kits are assembled in the Assembly Bays 65. Typical types of kits that could be built are a modified Belaz® 75600, Caterpillar® 795f AC, Hitachi® EH5000Ac-3, and many others. Modified trucks use nuclear-power packs with planetary dust and radiation protection; plus dumping bed areas are covered for ambient regolith dust control. Equipment can be remotely piloted or under direct human control. A critical part of this embodiment is the evolving for lunar regolith processing, refining, manufacturing, and packaging plus of Helium-3 (He3) 52 and 53 and strategic materials (SM) 54 and 55. The methods performed within the screening tunnel 52 require taking concentrated regolith [fines] smaller than 50 micrometers which require high pressure screening methods as well as making use of advanced sorting techniques of all collected materials within other sorting tunnels 52 and 54 will be challenging. Further, processing of helium would require isotope distillation methods to obtain He3 from the more prevalent He4 isotope. The isotope distillation processing is performed within the autonomous He3 Production Facility 53. In the autonomous SM Production Facility 55, computer networks and a plurality of sensors and associated machinery process regolith and bedrock into Iron (II) Titanate (FeTiO3) and then into its basic components of Titanium, Iron and Oxygen. Other processing methods in facility 55 will just produce Iron (II) Titanate mineral as an aggregate in high-density concrete used for lunar construction and underground tunnels.

Processed and packaged He3 and SM materials are ready for transport off the planet surface to an awaiting space barge 59 to the GEO space dock, as described by within U.S. Non-provisional application Ser. No. 14/998,744 dated 9 Feb. 2016 [P04]. The transportation and launch preparation methods for the awaiting space barge are scheduled by crewmembers of the Space Operations Command Facility (SOCF) 57. One method is to use the maglev launch ramp 56 to launch autonomous delivery spacecraft 58 to the barge 59. Then, a space barge 59 will return to the complex for a continuous looped delivery. A second method is loading a container FIG. 9 and FIG. 10, 20 onto the Dust-off Landing (DoL) Device FIG. 11, 19 to bring finished products or personnel to the space barge 59, which enters the trans-planetary pipeline and returns to a geosynchronous orbit space complex for storage and further processing.

The Headquarters Command Facility (HCF) 60 centrally controls all facets of the complex daily operations 50, 51. Within the HCF 60, all equipment are networked together so that all processing, mining and construction methods are programmed for autonomous or remote operations control and all equipment is continuously health monitored. The launch SOCF facility 57 performs all methods of all facets of the flight operations. The SOCF 57 reports continuously the updated health and performance data to the HCF 60. Both facilities 57, 60 will provide safe and comfortable living accommodations for crewmembers and laboratories for researchers.

Unlike the embodiment 11 which is a strategic mining complex built on a generally stable surface, Europa's surface is very vibrant with the presence of very mobile material strata and a deep subsurface ocean <100 kilometers below. This subsurface ocean reaches the surface through violent geysers and gas eruptions. Another influence on all mining methods and devices is the strong gravitational “pull” that Jupiter has on the moon, which is locked into an orbit with one hemisphere constantly facing Jupiter. This elliptical orbit takes Europa alternatively closer to and farther away from the planet. This alternating increase and decrease of powerful gravitational forces on Europa's surface results in the moon elongating and relaxing to approximately 35 feet with each trip around the planet. This internal movement combined with gravitational forces exerted by neighboring moons produces internal friction and heat within Europa, which is bombarded with radiation from Jupiter.

Europa's hostile surface dynamics drives all the methods and devices 70, 71, 72 in the operation of a system of systems environment embodiment 12, as illustrated at FIG. 12. FIG. 12 is a conceptual representation of a Europa system of systems 70 for a water extraction and purification-mining complex 71 that is supported by the trans-orbital systems 72.

Because of a continuous threat of eruptions and earthquakes, the production method of a water extraction and purification mining complex 71 requires all equipment and systems to be mounted on Rapid Take-off Dust-off Landing (RT-DoL) Devices 19. The mining operation begins with the landing and placement of the Equipment Maintenance Facility Modules 40, which provides for both research vehicles and heavy construction equipment that are capable of establishing operations. The crew habitation (CH) facility 83 with an accompanying command, research, and simulation center facility 82 are landed, placed into position, and made operational. Each living and work habitation facilities 40, 82, 83 provides for extreme radiation protection as exhibited at FIG. 6, 18A, as discussed by U.S. non-provisional application Ser. No. 15/202,633 dated 6 Jul. 2016 [P09].

Once the Europa Systems are operational, a plurality of DoL Devices 19 mounted 1500 kW nuclear power laser boring devices FIG. 12, 73 will employ boring technology to a depth of 100-kilometers, as adapted from U.S. Pat. No. 3,280,923A dated Oct. 25, 1966. With this adapted technology, there will be no need to supply and install 100-km well casings per bore 73 since a Europa laser boring apparatus creates its own thick casing liner. This casing liner is a modification of apparatus, as cited in U.S. Pat. No. 3,693,731 dated Sep. 26, 1972 that will be capable of handling the extreme deep depths and pressures. With previously stated planetary dynamics and pressures, other types of temporary boring and initial water quality testing reservoir 78 methods will provide underground constructed reservoirs before reaching surface operations.

After the water reaches the surface through the drilling platforms 73, this high-pressure water under pressure-controlled flowing through pipeline 74 through an array of water quality sensors prior to entering the initial holding tanks 75. At the initial holding tanks, an array of first phase water quality sensors adopting a JPL-developed Portable Remote Imaging Spectrometer (PRISM®) systems analysis method to gauge water quality. The second phase testing methods in the holding tank 75 continually tests for microbial contamination and bacteria possibly unknown to our standard testing methods, which could prevent humans and even robots from visiting the most promising parts of any exoplanet or watery moon. To reduce risk of microbial contamination, the scanned and tested water in the holding tank 75 is pumped to the autonomous Ultra Filtration/Reverse Osmosis Processing Unit (UFROPU) DoL (UFROPU-DoL) 76 for purification.

After purification, additional production processes are performed at a UFROPU-DoL 76 to separate any minerals from the purified water. These minerals will enter a plurality of secondary separation holding tanks 77 to collect free oxygen (O₂), hydrogen peroxide (H₂O₂), carbon dioxide (CO₂), sulfur dioxide (SO₂), magnesium (Mg), sodium (Na), potassium (K), and chlorine (CI). These separated minerals and gases are packaged and readied for transport 85 in a Cargo-DoL 19 for delivery to an awaiting orbiting Space Barge 59. The Space Barge 59 departs and enters the trans-planetary pipeline and returns to earth's geosynchronous space complex for processing and storage as reflected in U.S. Non-Provisional application Ser. No. 14/998,744 dated 9 Feb. 2016 [P04].

The purified water in the Transportation Holding Tank(s) 78 is pumped under pressure to the loading area 79 and into awaiting Water Transport DoL's 80 (WT-DoL). After the loading methods are completed, WT-DoL 80 follows the Follow Me Vehicle 81 to the launch pad. After lift-off, the WT-DoL 80 transports its cargo to an awaiting orbiting Trans-Planetary Delivery System (TPDS) FIG. 7, 22 modified to transport several millions of gallons of purified water to the geosynchronous space complex for processing and storage.

### BRIEF DESCRIPTION OF THE DRAWINGS

The embodiments of this present invention are supported by the following:

FIG. 1 Event Flow Diagram of repeatable tasks and swim lane processes to bring an approved new planetary construction project from project start to mission completion and returned for next mission.

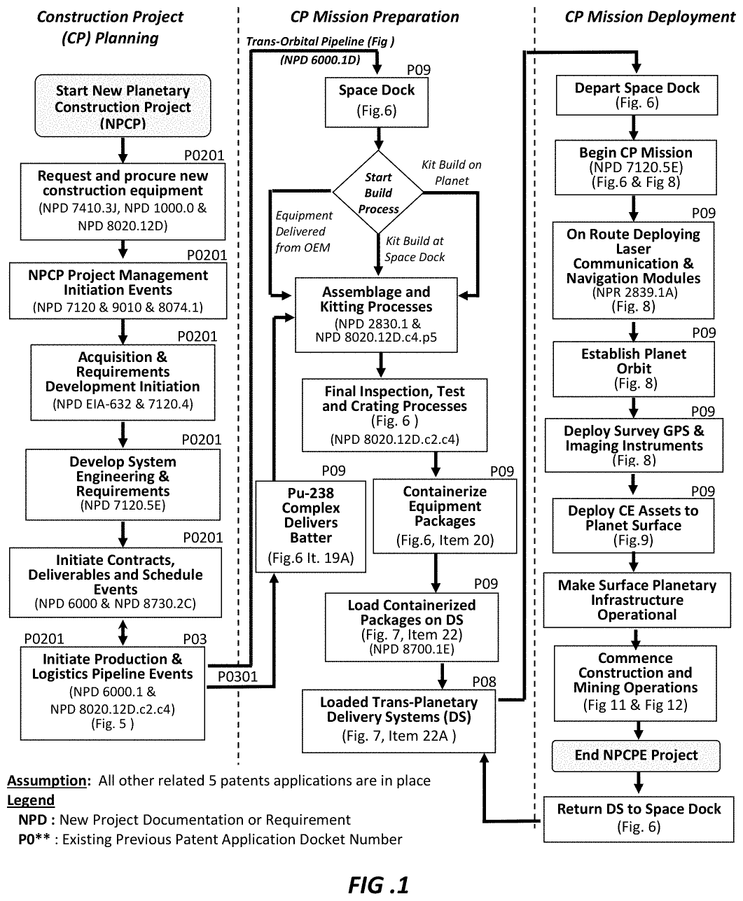

FIG. 2 Isometric view of all major components universal power train with a scale nuclear power pack.

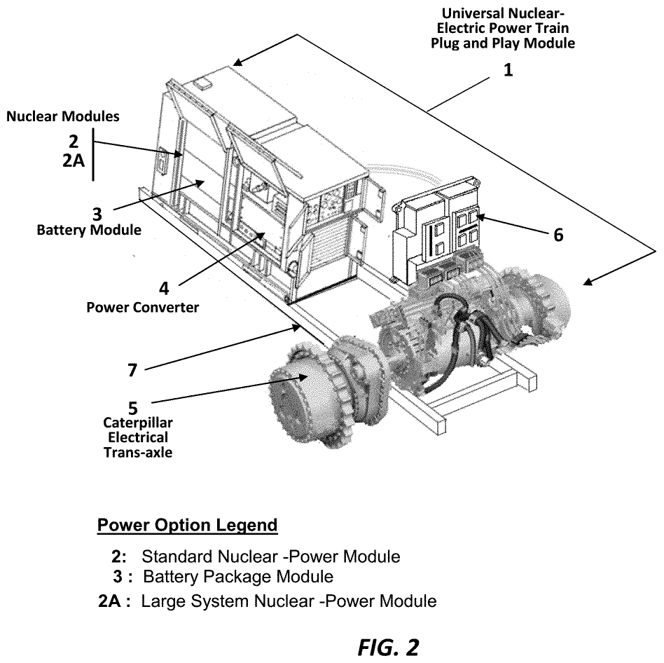

FIG. 3 Isometric view of the conversion process of installing components universal power train and other major electronic systems into a typical exo-planetary bulldozer.

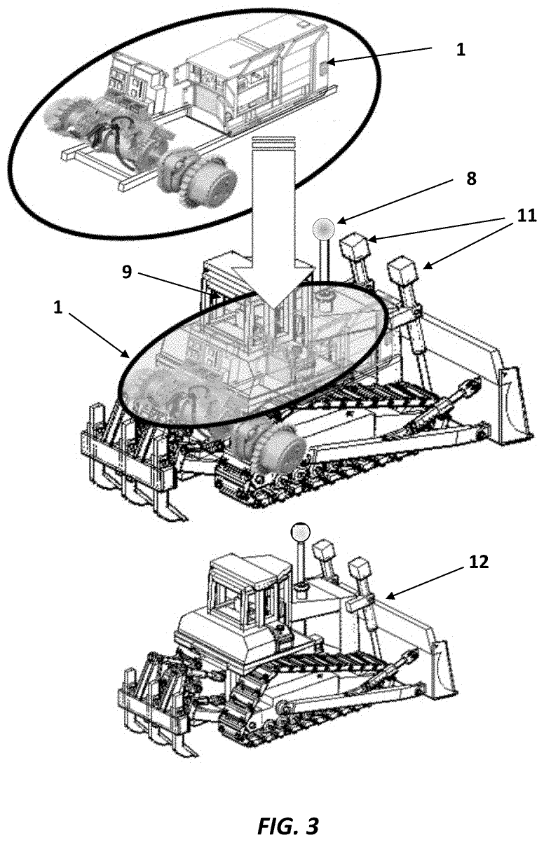

FIG. 4 Pictorial view showing the planet mining infrastructures using nuclear-power pack modules and various kits methods to be built.

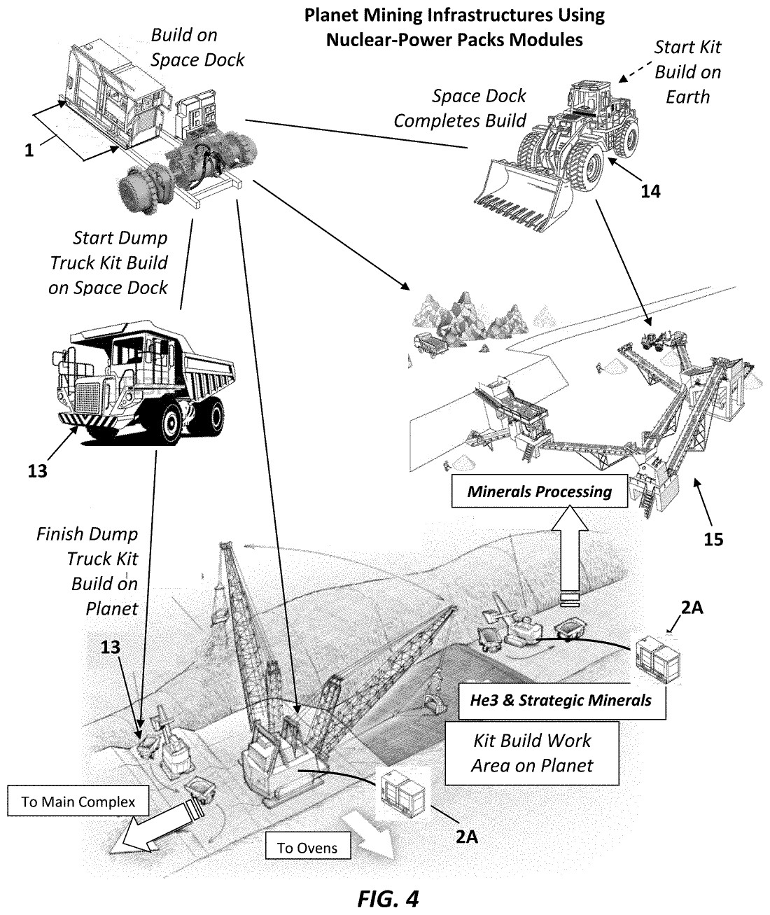

FIG. 5 Pictorial process flow diagram moving any component from a manufacturer to a spaceport to an awaiting trans-orbital freight carrier

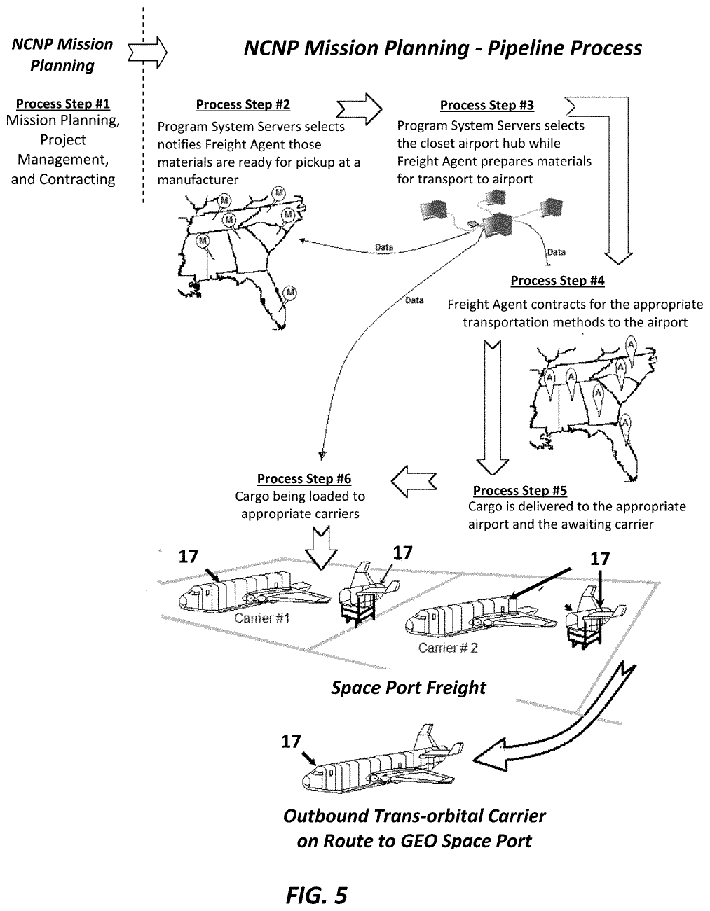

FIG. 6 Isometric view of the arrival trans-orbital freight carrier to build the space dock complex and the trans-planetary deliver system.

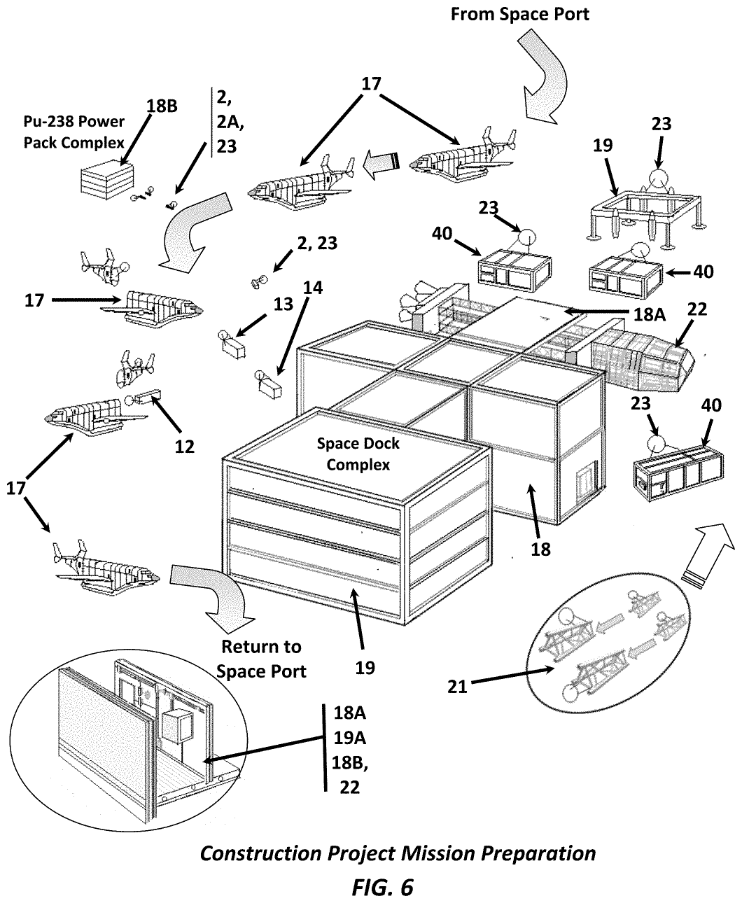

FIG. 7 Isometric view showing a typical unloaded trans-planetary deliver system and a loaded trans-planetary deliver system delivery cargo to a planetary mining complex.

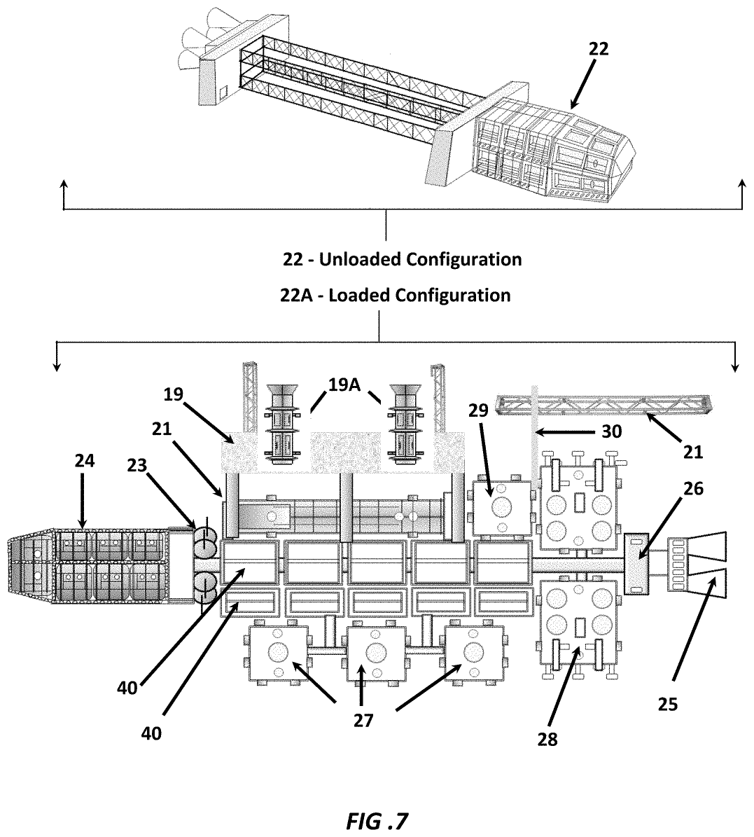

FIG. 8 Pictorial view of an arrival trans-planetary deliver system to set-up a planetary mining complex for remotely piloted operation.

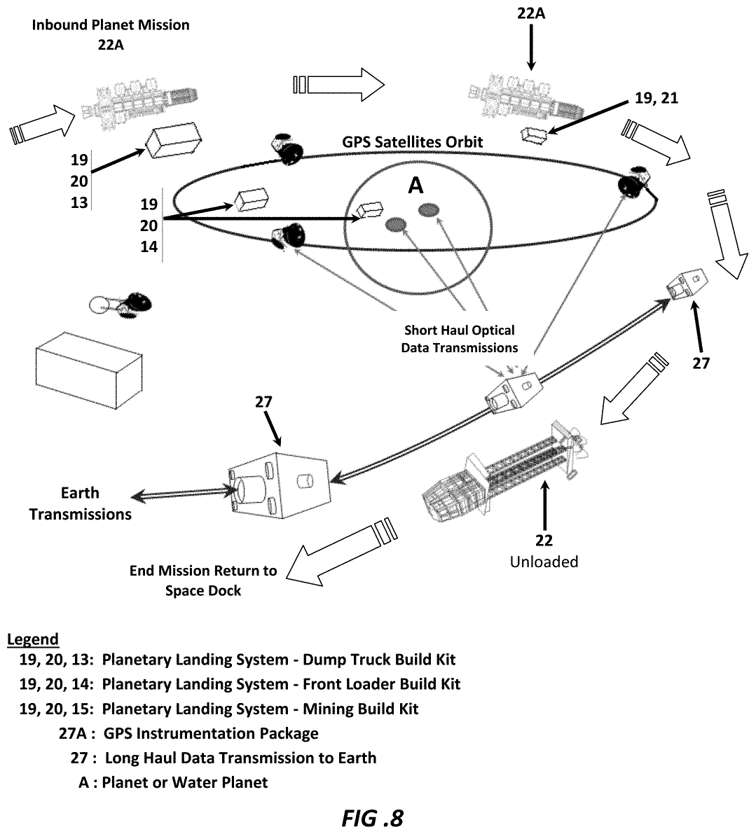

FIG. 9 Pictorial view of Dust-Off Landing (DoL) Device delivering a typical Equipment Maintenance Facility Module for a front loader vehicle.

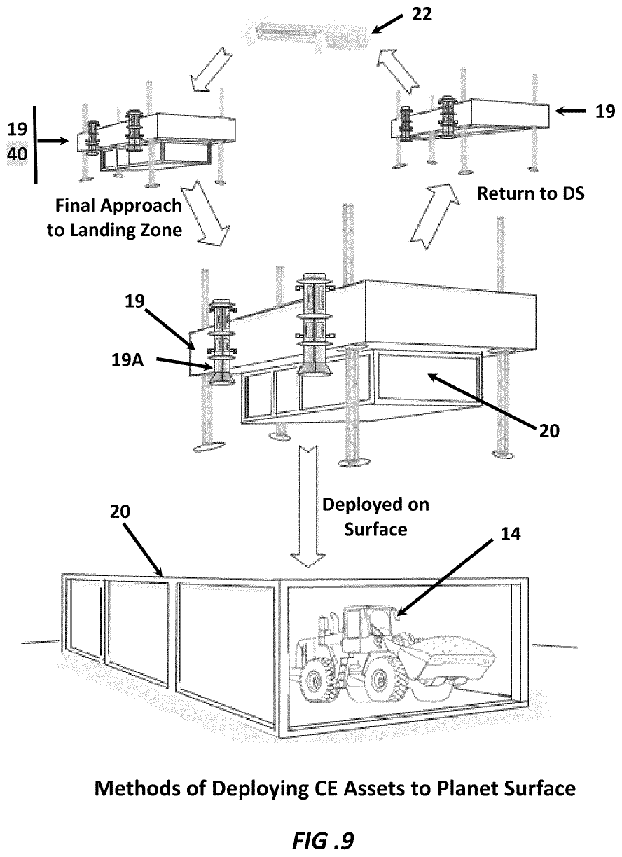

FIG. 10 Isometric and cut-away view of a typical Equipment Maintenance Facility Module for a bulldozer

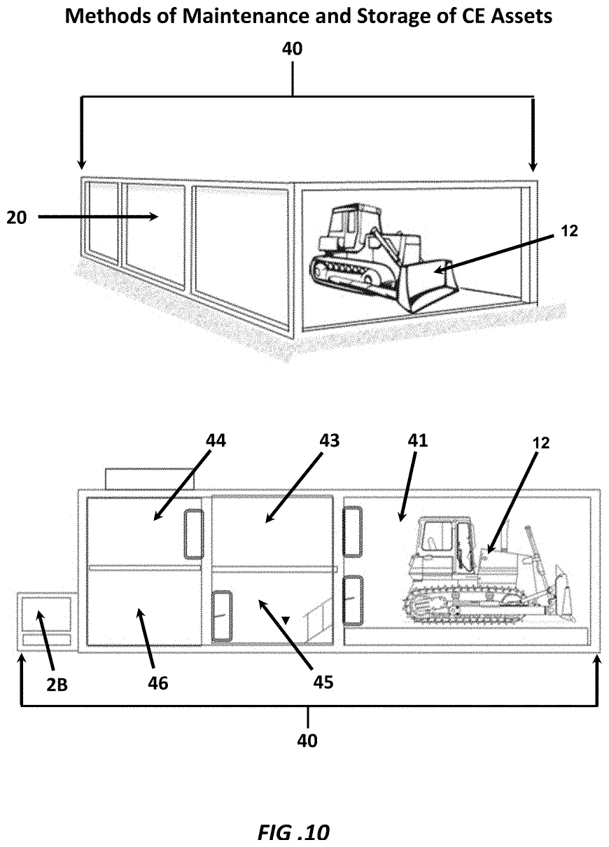

FIG. 11 Pictorial view of conceptual strategic mining complex.

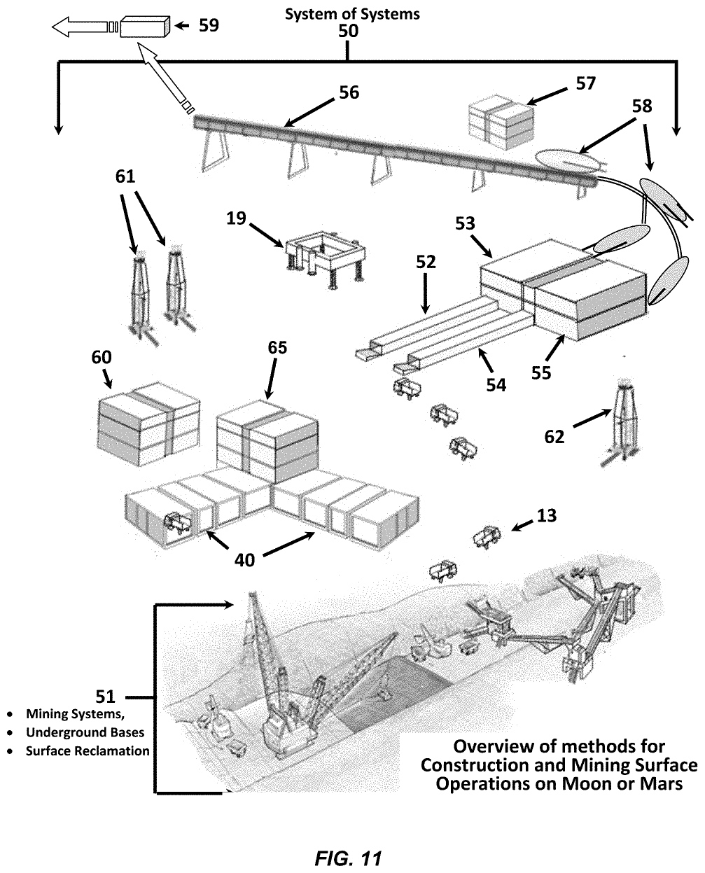

FIG. 12 Pictorial view of conceptual water extraction complex on Europa or any watery planet.

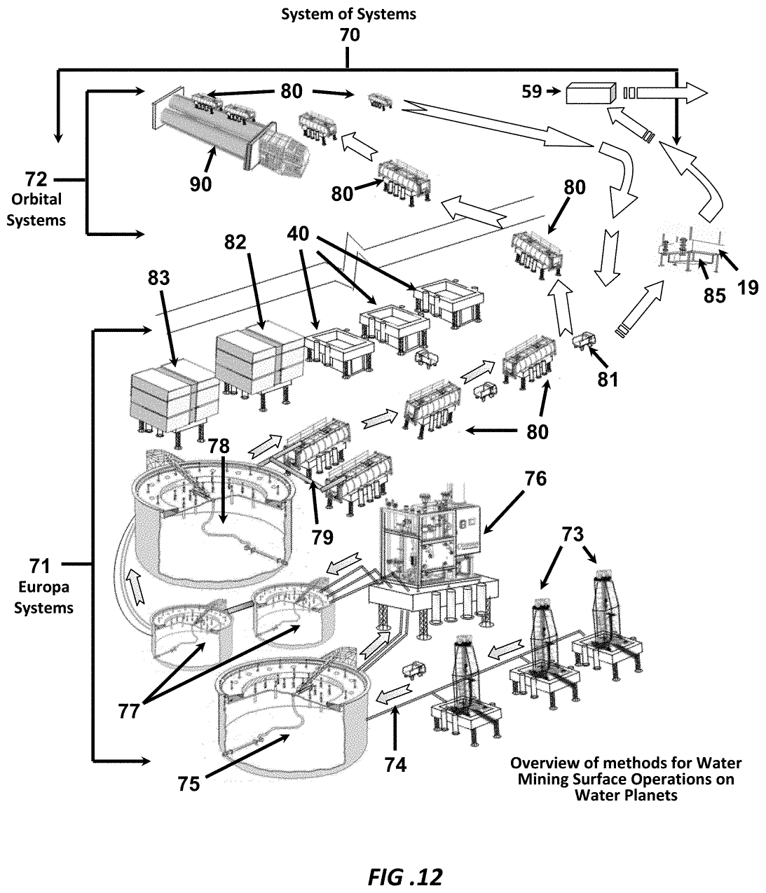

1. Water extraction and purification mining complex comprising of:
mobile ice penetration drilling platform(s) mounted on a rapid dust-off landing device wherein performing a plurality of methods engaging methods of a high capacity nuclear boring machine to produce large bore holes in ice and rock mixture by simultaneously detaching the bored core by thermal melting a boundary kerfs into the boring face thus forming a supportive rigid ice wall liner by deflecting the molten materials against the excavated walls to provide, when solidified, a continuous pressure tight wall supporting liner, as adapted from U.S. Pat. No. 3,881,777A rock-melting penetrator methods is particularly applicable from beneath any planet's surface operating at a temperature averaging 1700° C. as adapted from U.S. Pat. No. 3,115,194A by William M. Adams;
mobile ultra-filtration/reverse osmosis processing unit mounted on a rapid dust-off landing device wherein performing a plurality of methods for ultra filtration membrane microbial contamination and bacteria purification that will continue further processing of incoming liquids to remove a solute dissolved or suspended particulates to finally deliver biologically and human acceptable pure water at a desirable rate of better than 70,900 liters/m² h as adapted from EP 2,616,168A1 by the Council of Scientific & Industrial Research;
mobile equipment maintenance facility module mounted on a rapid dust-off landing device wherein this said facility provides two partitioned areas with one area to remotely operate equipment networked to a simulation/training systems while the second partitioned work area to maintain, fabricate, diagnose, and repair heavy construction, mining and drilling equipment;
rapid dust-off landing devices wherein a plurality of nuclear propulsion systems are attached to device body frames that are permanently mounted on all capital equipments mirroring a helicopter operation to rapidly lift off a facility from a planetary surface when sensors detect a lethal geyser or earthquake situation endangering any portion of a mining operation, or to relocate to another mining location, or transport cargo or personnel to a trans-planetary delivery system;
autonomous trans-orbital water delivery spacecraft(s) mounted on a rapid dust-off landing device wherein makes continuous transport of purified potable water from the planet surface to an awaiting trans-planetary delivery system or space barge spacecraft;
final kit assemblage and testing module wherein all processes to complete and field extremely large nuclear-powered equipment of all heavy mining and construction equipment, drilling equipment and strip and tunnel mining equipments employing a mixture of autonomous and remotely piloted equipments;
dual autonomous and remotely operated processing operation for a Helium 3 (He3) extraction, wherein, the said operation further provides production operation using networked processors, plurality of sensors, real-time camera images, operations in the planets regolith processing, refining, production and packaging facilities thus requiring high pressure temperatures of 900° F. and plurality of screening methods is applied with advanced sorting techniques of collected materials;
command, research and simulation center facility, wherein a plurality of complex management, scientific research, and mission training processes are performed concurrently ensuring a highly productive mining environment; monitor the complex systems health, safe work and living environment, and ensuring timely delivery to the trans-planetary pipelines;
mobile space operations command facility wherein enabling a plurality of methods for managing multiple dust-off landing devices during ground operations with concurrent multiple launch and landing operations using networked processors with human interactions mirroring U.S. Pat. No. 9,218,744 B2 by GE Company;
mobile crew compartment housing facility wherein the external environmental and radiation protection provides a comfortable and sustainable living habitation for long duration stays on the planet surface using nuclear power module to provide power to all life support and electronic systems.

2. Strategic materials mining and processing complex comprising of:
adopting and adapting traditional mining and refining systems methods using modified heavy equipments, wherein;
final kit assemblage and testing module wherein all processes to complete and field extremely large nuclear-powered equipment of all heavy mining and construction equipment, drilling equipment and strip and tunnel mining equipments employing a mixture of autonomous and remotely piloted equipments;
space operations command facility having a plurality of methods for managing multiple dust-off landing (RT-DoL) device wherein the said device performs ground operations with concurrent multiple launch and landing operations using networked processors with human interactions mirroring U.S. Pat. No. 9,218,744 B2 by GE Company;
equipment maintenance facility modules of claim 1 wherein the said facility provides areas to remotely operate equipment and/or simulate/training mission operations while providing a suitable partitioned area to maintain, diagnose, and repair heavy construction and mining equipment;
dual autonomous and remotely operated processing operation of strategic minerals mining complex wherein the said complex provides capabilities to strip and tunnel mine, mineral separation, and process and pack for off-planet transport using a plurality construction equipment guided by network processors, real-time camera images and remotely controlled operations;
ground transportation pipeline wherein the said pipeline comprised of a fleet of large dust control covering and environmentally protected nuclear powered dump trucks carries raw materials and regolith to the processing facility;
trans-orbital delivery systems wherein a fleet of dust-off landing devices transports a mixed cargo, water and passengers from a mining complex planet surface to and awaiting trans-planetary delivery space barges or other spacecraft.

3. Trans-planetary pipeline providing plurality autonomous, remotely operated or human method of a continuous transportation from the said complex in claim 1 and claim 2 into a GEO or a LaGrange Moon orbit wherein an array of trans-planetary delivery systems, space barges and other spacecraft become available.
